(19) United States
(12) Patent Application Publication
(10) Pub. No.: US 2024/0071105 A1
(43) Pub. Date: Feb. 29, 2024

(54) CROSS-MODAL SELF-SUPERVISED LEARNING FOR INFRASTRUCTURE ANALYSIS

(71) Applicant: NEC Laboratories America, Inc., Princeton, NJ (US)

(72) Inventors: Samuel Schulter, Long Island City, NY (US); Bingbing Zhuang, San Jose, CA (US); Vijay Kumar Baikampady Gopalkrishna, Santa Clara, CA (US); Sparsh Garg, San Jose, CA (US); Zhixing Zhang, Piscataway, NJ (US)

(21) Appl. No.: 18/453,439

(22) Filed: Aug. 22, 2023

Related U.S. Application Data
(60) Provisional application No. 63/400,420, filed on Aug. 24, 2022.

(51) Int. Cl. G06V 20/56; G06V 10/774; G06V 10/80; G06V 10/82

(52) U.S. Cl. CPC G06V 20/588; G06V 10/7753; G06V 10/811; G06V 10/82; G06V 2201/07

(57) ABSTRACT

Methods and systems for training a model include pre-training a backbone model with a pre-training decoder, using an unlabeled dataset with multiple distinct sensor data modalities that derive from different sensor types. The backbone model is fine-tuned with an output decoder after pre-training, using a labeled dataset with the multiple modalities.

### RELATED APPLICATION INFORMATION

This application claims priority to U.S. Patent Application No. 63/400,420, filed on Aug. 24, 2022, incorporated herein by reference in its entirety.

### BACKGROUND

### Technical Field

The present invention relates to infrastructure analysis and, more particularly, to machine learning systems to analyze infrastructure condition.

### Description of the Related Art

Maintaining road infrastructure is an ongoing need. Defects need to be identified, such as by rut-level estimation, crack detection, and faded-line detection. Additionally, cataloging scene elements may be performed to identify temporary road elements, such as in construction zones. These tasks use both a semantic and geometric understanding of the road scene.

### SUMMARY

A method for training a model includes pre-training a backbone model with a pre-training decoder, using an unlabeled dataset with multiple distinct sensor data modalities that derive from different sensor types. The backbone model is fine-tuned with an output decoder after pre-training, using a labeled dataset with the multiple modalities.

A method for training a model includes pre-training a backbone model with a pre-training decoder, using an unlabeled dataset with multiple distinct sensor data modalities that derive from different sensor types. Pre-training includes masking a part of the unlabeled dataset, reconstructing the masked part of the unlabeled dataset to generate a reconstruction, and updating parameters of the backbone model based on a reconstruction loss between the masked part of the unlabeled dataset and the reconstruction. The backbone model is fine-tuned with an output decoder after pre-training, using a labeled dataset with the multiple distinct sensor data modalities, including optimizing parameters of the output decoder according to a task-specific loss function distinct from the reconstruction loss.

A system for training a model includes a hardware processor and a memory that stores a computer program. When executed by the hardware processor, the computer program causes the hardware processor to pre-train a backbone model with a pre-training decoder, using an unlabeled dataset with multiple distinct sensor data modalities that derive from different sensor types, and to fine-tune the backbone model with an output decoder after pre-training, using a labeled dataset with the multiple distinct sensor data modalities.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a road scene where a vehicle is mounted with sensors of different modalities to collect information regarding defects in the road, in accordance with an embodiment of the present invention;

FIG. 2 is a block/flow diagram of a method of training and using a road defect detection model that makes use of unlabeled training data in multiple sensor modalities, in accordance with an embodiment of the present invention;

FIG. 3 is a block diagram of a road defect detection model that is pre-trained with unlabeled training data in multiple sensor modalities and that is fine-tuned with a limited set of labeled training examples, in accordance with an embodiment of the present invention;

FIG. 4 is a block diagram of a computing system that can perform model pre-training, model fine-tuning, and road scene processing, in accordance with an embodiment of the present invention;

FIG. 5 is a diagram of a neural network architecture that may be used to implement part of the road detection model, in accordance with an embodiment of the present invention; and

FIG. 6 is a diagram of a neural network architecture that may be used to implement part of the road detection model, in accordance with an embodiment of the present invention.

### DETAILED DESCRIPTION OF PREFERRED EMBODIMENTS

Machine learning may be used to determine road conditions using multiple modalities of information. For example, a visual image of a scene may be combined with information from LiDAR sensors. Rather than using a fully supervised training process, self-supervised pre-training is employed without manual annotation of the specific road conditions depicted in the training data. Supervised fine-tuning may then be used with a limited set of annotated training data.

The different sensor modalities may be combined. For example, the sensors may include multiple cameras mounted on a vehicle, along with a 360-degree LiDAR sensor. The unlabeled data may be used directly for pre-training, while the labeled data may include labels that identify characteristics of the captured scene. Using two different types of sensors allow a machine learning model to gather both a semantic and a geometric understanding of the state of road infrastructure.

To this end, a machine learning model may be pre-trained using a self-supervised approach, followed by a supervised fine-tuning stage with a limited number of annotated examples. Captured data from the different sensors is combined to enable training from large amounts of unlabeled data.

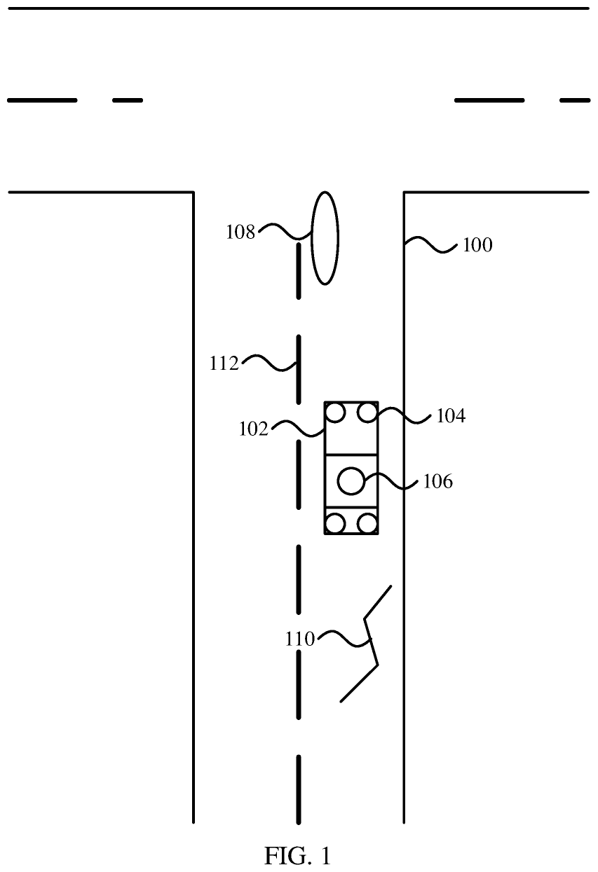

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree LiDAR sensor 106, positioned to gather geometric information about the road 100 all around the vehicle 102.

The vehicle 102 records information from its sensors. The vehicle 102 may be used to collect information about the road 100 by driving across as many roadways in an area as possible. The information may be used to identify defects in the road 100, and that information can be used to correct the identified defects and improve road quality and safety.

Exemplary defects include potholes 108, ruts, cracks 110, and fading in road markings 112. These defects may appear on one or both modalities. For example, LiDAR information is sensitive to geometric information and will indicate the shape of the road's surface. This is particularly useful for detecting potholes 108 and cracks 110, but LiDAR sensors 106 may have difficulty identifying defects in the road markings 112. The visual sensors 104, meanwhile, would be well adapted to defects in road markings 112, but may miss potholes 108 and cracks 110 in adverse lighting conditions. Additionally, when used in combination, the different modalities reinforce one another and provide superior results even in cases where each would independently be able to recognize the road defect.

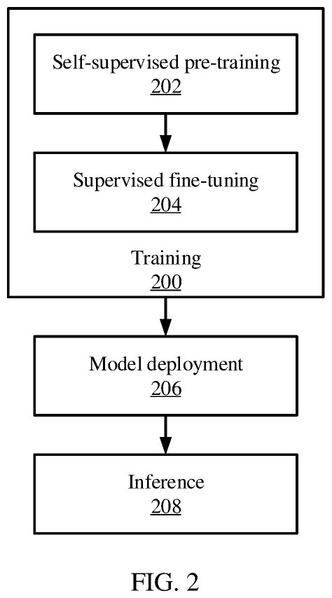

Referring now to FIG. 2, a method of training and using a road defect detection model is shown. A training step 200 uses a collection of unlabeled multimodal data to perform self-supervised pre-training 202 of the model, followed by supervised fine-tuning 204 of the model using a more limited set of annotated multimodal data.

The trained model is deployed 206. The deployed model may be used in a central facility that collects data from roads 100 and coordinates repair actions. In other embodiments, the model may be deployed to vehicles 102 to assist in real-time detection of road defects and hazards, for example to provide information about hazards to the driver of the vehicle or to aid in self-driving functionality. Once it has been deployed, the model may be used to process new data captured from a road 100 to identify defects with inference 208.

The pre-training 202 makes use of an unlabeled dataset, for example including visual images (e.g., made up of red-green-blue (RGB) pixel data), LiDAR point clouds, and calibration information. There may be N unlabeled training examples. The visual images may include multi-view RGB data, with images taken from multiple cameras at any given time. The LiDAR data may include a three-dimensional point cloud that indicates three-dimensional points from which a laser reflected. The calibration information relates the video cameras 104 and the LiDAR sensor 106 to one another, indicating the relative translations and rotations between the different sensors, as well as intrinsic calibration information for each sensor.

The fine-tuning 204 makes use of a labeled dataset that includes the same types of information as the unlabeled dataset, but additionally includes annotations. The annotations may be generated manually by human operators or may be generated automatically. Different types of annotation may be appropriate for different types of model tasks. For example, three dimensional semantic segmentation is task that attempts to label regions of an image according to their nature or function. The labeled dataset for such a task may therefore include semantic category labels for regions in the training examples. For an object detection task, a bounding box for objects in the scene may be annotated.

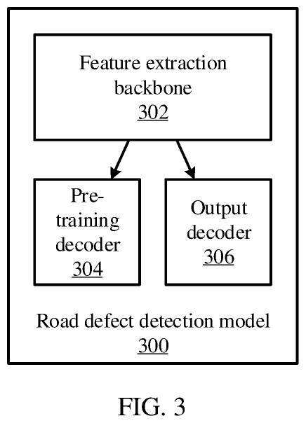

Referring now to FIG. 3, a diagram of a road defect detection model 300 is shown. Pre-training 202 seeks to train a backbone 302 of the model for feature extraction, to serve as a starting point for the fine-tuning 204. A pre-training decoder 304 may be designed for the use of unlabeled data.

For example, the input data may first be tokenized, with fixed-sized patches of the RGB pixel information and voxels for the LiDAR point cloud. The tokenization of the LiDAR point cloud may include voxelization based on Cartesian coordinates or cylindrical coordinates. The three-dimensional points may be processed without mapping onto a two-dimensional grid of a depth map. In some cases, only non-empty voxels and their immediate neighbors may be considered.

Parts of the input may be masked based on a sampling scheme and the model may be tasked with reconstructing the missing portions. The sampling scheme may depend on the availability of multiple input cameras for the input dataset. If multiple cameras are available, then the network can be asked to reconstruct one side of the scene from another, with a combination of inputs from RGB data and LiDAR data. The objective function for the pre-training may be, for example, a reconstruction loss. The reconstruction may predict if a masked voxel is empty or not, and may predict a point-cloud feature vector for a masked voxel.

Given the pre-trained backbone 302, an output decoder 306 may be trained using the labeled training dataset during fine-tuning 204. The backbone 302 uses parameters obtained from pre-training 202, which are held constant during fine tuning 204, and the parameters of the output decoder 306 are updated to minimize a new objective function for the particular task at hand. In some cases, the parameters of the output decoder 306 may be initially copied from the pre-training decoder 304 and may be retrained during fine-tuning 204. In some cases, the parameters of the output decoder 306 maybe reinitialized to random values, some predetermined constant value (e.g., zero), or to any other appropriate initial values.

The pre-training decoder 304 and the output decoder 306 may differ from one another. The pre-training decoder may be a model that predicts, for example, whether a voxel is empty or not, or it may predict the values of the masked-out RGB patches. The output decoder 306 is task-dependent. For example, if the task is to detect ruts or cracks, the output decoder 306 may take multi-modal features from the pre-trained backbone 302 and then, for each pixel in the image (or also for each voxel), predict whether the pixel contains a rut or crack. That would be a binary classifier for each area in the input data. Another example would be to also predict the depth of a rut, where the output would be a continuous value (e.g., in millimeters), also for each area in the image.

The model 300 may be implemented as an artificial neural network. The backbone 302 may be used to extract feature vectors from a raw input and may be implemented as, e.g., a transformer architecture. The computational complexity of a transformer architecture scales quadratically with the input size, which can pose challenges for three-dimensional data such as the LiDAR point cloud. The backbone 302 may therefore include a Perceiver-like architecture that has a fixed size of latent variables, independent of input size.

The pre-training decoder 304 and the output decoder 306 take the feature vectors generated by the backbone 302 and makes task-specific predictions. The particular structure of the decoders may reflect the task at hand. The number of learnable parameters in the decoders may be significantly lower than in the backbone 302. The decoders may be implemented as transformers, taking multiple tokens, with each token including a content and a location within an image. The output decoder may accept as input the positions for which a prediction s needed, with a freely learnable content part. The transformer may use cross-attention, with features extracted from the backbone 302, to gather information from the input data.

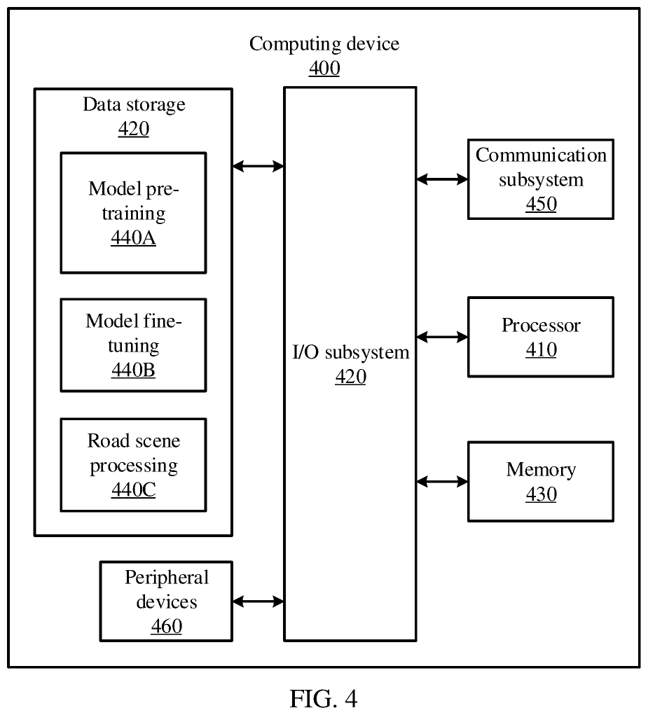

Referring now to FIG. 4, an exemplary computing device 400 is shown, in accordance with an embodiment of the present invention. The computing device 400 is configured to perform road defect detection.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for pre-training a model, 440B for fine-tuning a model, and/or 440C for road scene processing. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

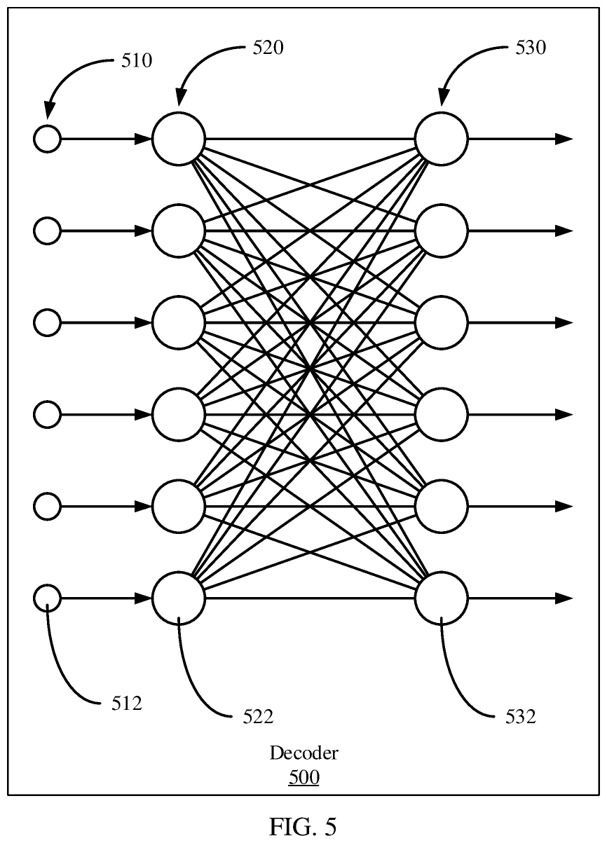

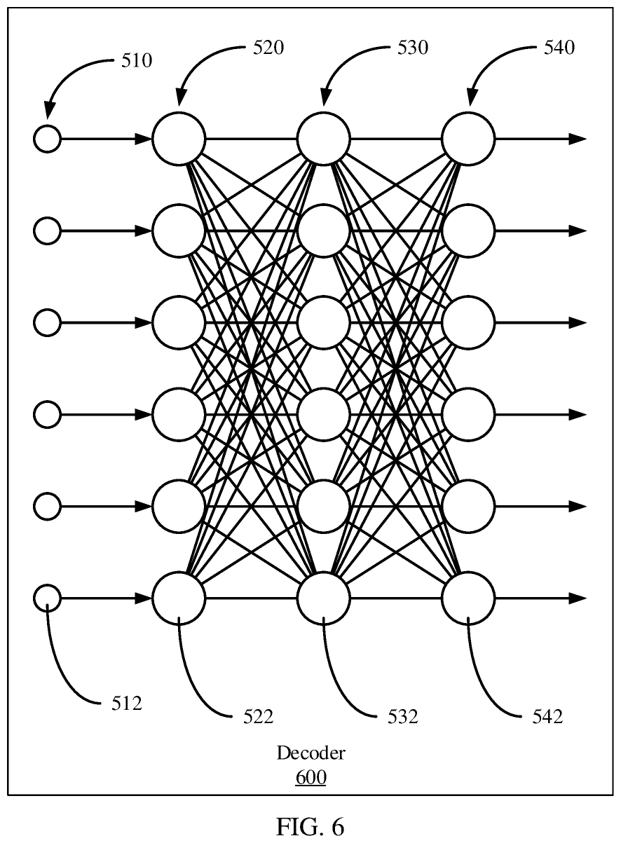

Referring now to FIGS. 5 and 6, exemplary neural network architectures are shown, which may be used to implement parts of the present models, such as the decoders. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . , wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
pre-training a backbone model with a pre-training decoder, using an unlabeled dataset with multiple distinct sensor data modalities that derive from different sensor types; and
fine-tuning the backbone model with an output decoder after pre-training, using a labeled dataset with the multiple modalities.

2. The method of claim 1, wherein the multiple distinct sensor data modalities include visual data from a video camera and point cloud data from a LiDAR sensor.

3. The method of claim 2, wherein the visual data includes data from multiple video cameras on a given vehicle.

4. The method of claim 1, wherein pre-training the backbone model with the pre-training decoder includes masking a part of the unlabeled dataset.

5. The method of claim 4, wherein pre-training the backbone model with the pre-training decoder includes reconstructing the masked part of the unlabeled dataset to generate a reconstruction.

6. The method of claim 5, wherein pre-training the backbone model with the pre-training decoder includes updating parameters of the backbone model based on a reconstruction loss between the masked part of the unlabeled dataset and the reconstruction.

7. The method of claim 1, wherein fine-tuning the backbone model with the output decoder includes holding parameters of the backbone model fixed while updating parameters of the output decoder.

8. The method of claim 7, wherein updating parameters of the output decoder include optimizing the parameters of the output decoder according to a task-specific loss function distinct from a loss function used in the pre-training.

9. A computer-implemented method for training a model, comprising:
pre-training a backbone model with a pre-training decoder, using an unlabeled dataset with multiple distinct sensor data modalities that derive from different sensor types, including:
masking a part of the unlabeled dataset;
reconstructing the masked part of the unlabeled dataset to generate a reconstruction; and
updating parameters of the backbone model based on a reconstruction loss between the masked part of the unlabeled dataset and the reconstruction; and
fine-tuning the backbone model with an output decoder after pre-training, using a labeled dataset with the multiple distinct sensor data modalities, including optimizing parameters of the output decoder according to a task-specific loss function distinct from the reconstruction loss.

10. The method of claim 9, wherein the multiple distinct sensor data modalities include visual data from a video camera and point cloud data from a LiDAR sensor.

11. The method of claim 10, wherein the visual data includes data from multiple video cameras on a given vehicle.

12. The method of claim 9, wherein fine-tuning the backbone model with the output decoder includes holding parameters of the backbone model fixed while updating parameters of the output decoder.

13. A system for training a model, comprising:
a hardware processor; and
a memory that stores a computer program which, when executed by the hardware processor, causes the hardware processor to:
pre-train a backbone model with a pre-training decoder, using an unlabeled dataset with multiple distinct sensor data modalities that derive from different sensor types; and
fine-tune the backbone model with an output decoder after pre-training, using a labeled dataset with the multiple distinct sensor data modalities.

14. The system of claim 13, wherein the multiple distinct sensor data modalities include visual data from a video camera and point cloud data from a LiDAR sensor.

15. The system of claim 14, wherein the visual data includes data from multiple video cameras on a given vehicle.

16. The system of claim 13, wherein the computer program further causes the hardware processor to mask a part of the unlabeled dataset.

17. The system of claim 16, wherein the computer program further causes the hardware processor to reconstruct the masked part of the unlabeled dataset to generate a reconstruction.

18. The system of claim 17, wherein the computer program further causes the hardware processor to update parameters of the backbone model based on a reconstruction loss between the masked part of the unlabeled dataset and the reconstruction.

19. The system of claim 13, wherein the computer program further causes the hardware processor to hold parameters of the backbone model fixed while parameters of the output decoder are updated.

20. The system of claim 19, wherein the computer program further causes the hardware processor to optimize the parameters of the output decoder according to a task-specific loss function distinct from a loss function used in the pre-training.
